(19) United States
(12) Patent Application Publication
(10) Pub. No.: US 2025/0215824 A1
(43) Pub. Date: Jul. 3, 2025

(54) IMPROVED PROPULSION ASSEMBLY FOR MULTI-ENGINE HYBRID AIRCRAFT

(71) Applicant: SAFRAN HELICOPTER ENGINES, Bordes (FR)

(72) Inventors: Romain Jean Gilbert THIRIET, Moissy-Cramayel (FR); Olivier BEDRINE, Moissy-Cramayel (FR)

(73) Assignee: SAFRAN HELICOPTER ENGINES, Bordes (FR)

(21) Appl. No.: 18/998,280

(22) PCT Filed: Jul. 26, 2023
(86) PCT No.: PCT/FR2023/051166

§ 371 Date: Jan. 24, 2025

(30) Foreign Application Priority Data
Jul. 27, 2022 (FR) FR2207742

(51) Int. Cl. F02C 6/20; F02C 3/10; F02C 3/113; F02C 6/02; F02C 7/268

(52) U.S. Cl. CPC F02C 6/206; F02C 3/10; F02C 3/113; F02C 6/02; F02C 7/268; F05D 2220/329; F05D 2220/76

(57) ABSTRACT

A propulsion assembly for a hybrid aircraft including a first and a second engine each having a gas generator and a free turbine, a main rotor coupled to the free turbine of the first and second engines, the first engine including a first electric machine and a second electric machine of lower power than the first electric machine, one of the first or of the second electric machine being able to be coupled to the gas generator and to set the gas generator in rotation during a start phase of the engine, and being further able to be coupled to the free turbine in order to generate electrical energy after the start phase, the other of the first or of the second electric machine being coupled to the gas generator only.

### TECHNICAL FIELD

The present invention relates to the field of hybrid aircrafts, comprising at least two engines such as turbine engines or turboprop engines, for flying vehicles such as helicopters or twin-engine airplanes. Particularly, the invention relates to a propulsion assembly for a multi-engine hybrid aircraft, in particular a twin-engine aircraft, a hybrid aircraft comprising such a propulsion assembly, and a method using such a propulsion assembly.

### PRIOR ART

In a known manner, a turbomachine, for example a turbine engine, in particular for a helicopter, includes a gas turbine having a gas generator and a free turbine driven in rotation by the gas stream generated by the gas generator.

Traditionally, the gas generator includes at least one compressor and one turbine coupled in rotation. The operating principle is as follows: the fresh air entering the gas turbine is compressed due to the rotation of the compressor before being sent to a combustion chamber where it is mixed with a fuel. The gases burnt due to the combustion are then discharged at high speed. A first expansion then occurs in the gas generator turbine, during which the latter extracts the energy necessary to drive the compressor. The turbine of the gas generator does not absorb all the kinetic energy of the burnt gases and the excess kinetic energy corresponds to the gas stream generated by the gas generator. The latter therefore provides kinetic energy to the free turbine so that a second expansion occurs in the free turbine which transforms this kinetic energy into mechanical energy in order to drive a receiving member, such as the rotor of the helicopter.

Some aircrafts include two turbomachines or more, each comprising a gas turbine as described above. This is in particular the case for twin-engine or multi-engine helicopters. Such aircrafts allow an operation in SEO (Single Engine Operative) mode. The SEO mode is an operating mode of a twin-engine architecture in which one of the gas turbines is voluntarily stopped, the other ensuring the entire power supply. This mode makes it possible to optimize the specific consumption, which decreases with the power provided by a turbomachine. Indeed, the specific consumption of a turbine decreasing with the power provided, it is indeed preferable to provide 100% of the power with one turbine, rather than 50% by each of them.

One of the critical points of the SEO mode lies in the ability to reignite the stopped turbine in case of power loss of the operating turbine. In order to ensure the fastest possible restart, it is possible to keep the stopped turbine in standby (or super idle) mode, that is to say continue to run its gas generator using exclusively an electric machine, without fuel delivery. The generator is then kept in its “ignition window” (typically 10-30% of the nominal rotational speed of the gas generator) in order to allow immediate ignition of the fuel, or in “super-idle” mode using a combustion at a low speed threshold and assisted by means of a mechanical power delivery via an electric machine, in order to benefit from a combustion chamber already lit but with a controlled internal temperature.

The twin-engine applications involve many functions, such as starting the gas generator, generating electricity on board, or providing mechanical power to the main rotor. Existing solutions for performing some of these functions are not entirely satisfactory. Particularly, they do not provide the redundancy necessary to the function of starting the engine which is in standby mode, nor limit the impact of the electrical draw from the engine when the helicopter is not operating in SEO mode. There is therefore a need for a twin-engine or multi-engine aircraft propulsion assembly with an architecture that meets at least partly the aforementioned drawbacks.

### DISCLOSURE OF THE INVENTION

The present disclosure relates to a propulsion assembly for a hybrid aircraft, in particular a multi-engine helicopter, comprising:
at least a first engine and a second engine each having a gas generator and a free turbine driven in rotation by a gas stream generated by the gas generator,
a main rotor coupled to the free turbine of the first and second engines,
the first engine comprising a first electric machine and a second electric machine of lower power than the first electric machine, one of the first or of the second electric machine being able to be coupled to the gas generator and to set the gas generator in rotation during a start phase of the engine, and being further able to be coupled to the free turbine in order to generate electrical energy after the start phase, the other of the first or of the second electric machine being coupled to the gas generator only.

The main rotor may be coupled to the free turbine of the first engine and of the second engine via a first and a second main coupling means respectively. Moreover, a shaft of the free turbine of each of the first and of the second engine may be in direct engagement with the main rotor, or via a mechanical reduction gear.

It is understood that according to the present disclosure, the first engine at least is equipped with a first electric machine and a second electric machine. In some embodiments, the second engine comprises a third electric machine, preferably of lower power than the first electric machine, able to drive the gas generator of the second engine during a start phase, and to be driven by said gas generator in order to generate electrical energy after the start phase.

Alternatively, the second engine could be equipped with the first and second electric machines, and the first engine could then be equipped with the third electric machine, or each of the first and of the second engine could be equipped with two electric machines in a symmetrical manner.

While one of the first or of the second electric machine is able to be coupled with the gas generator and/or with the free turbine depending on the operating phases and the architecture of the engine, the other electric machine is coupled only to the gas generator. The first electric machine is furthermore dimensioned so as to be able to provide a higher power than the second electric machine, in particular for quick start phases. The first electric machine is therefore of high power, of the order of one or several hundred kilowatts, while the second electric machine (and the third electric machine of the second engine where appropriate) is of low power, of the order of 10 kW, such as a generator/starter usually used in aircraft engines.

According to this configuration, one of the first or of the second electric machine is able to be coupled to the free turbine, at least after the start phase of the turbine engine in order to generate electrical energy. In other words, in flight, the free turbine advantageously drives in rotation said first or second electric machine, operating as an electric generator, so that the kinetic energy intended to be transformed into electrical energy is advantageously drawn from the free turbine, and not from the gas generator. This makes it possible to provide electricity while limiting the impact on the efficiency of the engine. As a result, the turbine engine according to the invention advantageously makes it possible to provide electricity without too much penalizing its efficiency.

It will be noted that in flight, when the electrical generation is carried out by said first or second electric machine driven by the free turbine of the first engine, the third electric machine, where appropriate, driven by the gas generator of the second engine, can be redundant or provide additional electrical power.

In addition, during an operation in SEO mode, when the second engine drives the main rotor alone, the first or the second electric machine of the first engine operating in standby mode can be used to keep the gas generator of this engine in rotation at low speed. The first high-power electric machine can also be used for a quick restart of the engine in standby mode, in particular in case of emergency. It is also possible to use the two electric machines at the same time in order to increase the power injected into the gas generator during the quick reactivation phase and therefore to reduce the reactivation time. In addition, the first or the second electric machine can be used independently in order to carry out a normal restart, thus allowing redundancy.

Consequently, the multi-engine architecture according to the present disclosure has the advantage of being simple by limiting the number of components and connections. Particularly, it improves the reliability of the start for the engine in standby mode as part of the SEO mode, and optimizes the engine performance by drawing via one of the electric machines on the free turbine after the start phase in conventional twin-engine operation. It is thus possible to rationalize and optimize the number of electric machines and the architecture of the propulsion assembly, while allowing a high number of functions to be performed, and reducing the mass of the device.

In some embodiments, the first electric machine is coupled to a shaft of the gas generator via first deactivatable coupling means configured to be activated during the start phase, and to be deactivated after the start phase.

By “deactivatable coupling means”, it is meant that the coupling means can be in an activated position in which the members connected to said coupling means are coupled, or in a deactivated position in which said members are decoupled, it being understood that by “member” it is meant the electric machines, the main rotor and the gas generator.

In accordance with the invention, the first electric machine is preferably reversible and operates as an electric motor when the first coupling means are activated, so as to drive in rotation the gas generator during the start phase of the engine. Correlatively, the first reversible electric machine operates as an electric generator so as to produce electricity by drawing kinetic energy from the free turbine, and this after the engine start phase, that is to say essentially in flight. During this post start phase of the engine, the first coupling means are deactivated such that the gas generator cannot drive the first electric machine.

It is understood that according to this embodiment, the second electric machine is coupled only to the gas generator. However, it will be noted that a configuration in which the second electric machine and the first electric machine are reversed is also possible.

In some embodiments, the first electric machine is coupled to a shaft of the free turbine by being in direct engagement therewith.

By “direct engagement”, it is understood that the first electric machine is coupled to the shaft of the free turbine by a simple shaft, or possibly by means of pinions, but that no deactivatable coupling means (for example a free wheel) is disposed between the first electric machine and the shaft of the free turbine.

In other words, while the first electric machine is coupled to the shaft of the gas generator by means of deactivatable coupling means, which can in particular be deactivated after the start phase, the first electric machine is coupled to the shaft of the free turbine by being in direct engagement therewith, such that the electric machine also drives the free turbine during a start phase of the engine and is always related thereto. This architecture makes it possible to reduce the total mass of the propulsion assembly.

In some embodiments, the first electric machine is coupled to a shaft of the free turbine via second deactivatable coupling means, the first and second deactivatable coupling means being configured so as not to be activated simultaneously.

When the second coupling means are activated, the first coupling means are deactivated, that is to say the first electric machine is coupled to the free turbine while being decoupled from the gas generator, while conversely, when the first coupling means are activated, the second coupling means are deactivated, that is to say the first reversible electric machine is coupled to the gas generator while being decoupled from the free turbine. Without departing from the framework of the invention, it is also possible to provide for an intermediate position in which the first and second coupling means are deactivated at the same time.

The first electric machine operates as an electric motor when the first coupling means are activated, so as to drive in rotation the gas generator during the engine start phase. Correlatively, the first reversible electric machine operates as an electric generator when the second coupling means are activated, so as to produce electricity by drawing kinetic energy from the free turbine, and this after the engine start phase, that is to say essentially in flight. In other words, the first electric machine is coupled to the free turbine only after the start phase.

Due to the fact that the first and second coupling means cannot be activated simultaneously, the occurrence of the undesired situation in which the free turbine drives in rotation the gas generator is avoided.

In some embodiments, the first deactivatable coupling means comprise a first free wheel, the second deactivatable coupling means comprise a second free wheel and the first and second free wheels are mounted in opposition.

One advantage of the free wheel is that it does not need to be controlled electronically or mechanically by an external operator. Such a free wheel is generally made up of a hub and of a peripheral ring gear rotatably mounted on the hub. The hub can drive in rotation the peripheral ring gear but not vice versa. Also, the hub can drive the ring gear only when the hub rotates in a predetermined direction, which will be called “direction of engagement”. Otherwise, the hub and the peripheral ring gear rotate freely relative to each other. In this case, the deactivatable coupling means are activated when the hub of the free wheel drives in rotation the peripheral ring gear and, conversely, the deactivatable coupling means are deactivated when the hub of the free wheel does not drive in rotation the peripheral ring gear.

By “mounted in opposition”, it is meant that the first free wheel can transmit a rotational torque coming from the first electric machine, while the second free wheel can transmit a rotational torque towards the first electric machine.

In some embodiments, the first deactivatable coupling means comprise a first reduction gear having a first reduction coefficient, while the second deactivatable coupling means comprise a second reduction gear having a second reduction coefficient, and the ratio of the first and second reduction coefficients is smaller than a limit value.

By “reduction gear” it is meant one or more reduction stages, including for example gear trains. Such reduction gears are known elsewhere. Since the gas generator and the free turbine generally rotate substantially faster than the first electric machine, the reduction gear makes it possible to adapt the rotational speed of the electric machine to the speeds of the gas generator and of the free turbine.

Preferably, the limit value is chosen such that the first and second free wheels are not engaged simultaneously. Preferably, this limit value is proportional to the ratio of the nominal speed of the gas generator to the nominal speed of the free turbine.

In some embodiments, when the second engine alone drives the main rotor, the gas generator of the first engine is kept in a standby mode, via the first or the second electric machine.

When the aircraft operates in SEO mode, the second engine, for example, ensures the entire power supply, while the first engine is voluntarily stopped, or preferably put into standby mode, in order to optimize the specific consumption. The standby mode makes it possible to keep the gas generator of the first engine in a range from 5 to 30% of its nominal rotational speed, in order to allow quick re-ignition if necessary, in particular when the second engine stops involuntarily.

It will be noted that when the first electric machine is in direct engagement with the shaft of the free turbine, and is used to keep the gas generator of the first engine in the standby mode, it inevitably drives the free turbine as well. This configuration is made possible by the fact that the free turbine of said first engine rotates at a lower speed than the main rotor, the first main coupling means then being deactivated.

In some embodiments, the second electric machine is coupled to the gas generator only, via a free wheel.

Consequently, the second electric machine can drive the gas generator during a start phase, but conversely, the gas generator cannot drive the second electric machine. The latter therefore remains at rest when it is not used. According to this configuration, only the first electric machine can therefore generate electrical energy.

The present disclosure also relates to a hybrid aircraft comprising a propulsion assembly according to any one of the preceding embodiments, the hybrid aircraft being a multi-engine helicopter, in particular a twin-engine helicopter.

By “hybrid aircraft” it is meant an aircraft comprising a heat engine for driving in rotation a main rotor, and at least one electric machine for providing power to the heat engine.

The present disclosure also relates to a method for optimizing the operation of a multi-engine aircraft using a propulsion assembly according to any one of the preceding embodiments, in which, during a start phase of the first engine, the first electric machine and/or the second electric machine drive the gas generator of said first engine, and after the start phase, the free turbine of said first engine drives one of the first electric machine or of the second electric machine in order to generate electrical energy.

In some embodiments, the second engine is able to operate alone, the first engine then operating in a standby mode by being driven at idle by the first or the second electric machine, the first engine operating in the standby mode being restarted by the first electric machine at least during a quick restart phase.

The power of the first electric machine being of the order of several tens to a few hundred kilowatts, it is possible to start the gas generator much more quickly by using the first electric machine at least during a quick restart phase.

In some embodiments, during a start phase of the first engine, the first electric machine and/or the second electric machine drive the gas generator of said first engine without driving the free turbine, when the first electric machine is coupled to the shaft of the free turbine via the second deactivatable coupling means comprising the second free wheel.

In a normal ground start configuration or to exit SEO mode, given the presence of the second deactivatable coupling means, neither of the first or of the second electric machines can drive the shaft of the free turbine. Either of the two electric machines, or both simultaneously, can therefore be used in SEO mode to keep the gas generator of the first engine in standby mode without driving the free turbine. Similarly, during a normal ground start or a normal reactivation in flight, that is to say in a non-emergency situation, either of the electric machines (or both) can be used without driving the free turbine.

In some embodiments, the second engine is able to operate alone and, when the first electric machine is coupled to the shaft of the free turbine of the first engine by being in direct engagement therewith, the first engine then operating in a standby mode is driven at idle by the second electric machine coupled to the gas generator only, or by the first electric machine, the main rotor being coupled to the free turbine of the first engine via a main coupling means, the main rotor driven by the second engine rotating at a higher speed than the shaft of the free turbine of the first engine such that the main coupling means is deactivated.

In this operating configuration in SEO mode, given the absence of deactivatable coupling means between the first electric machine and the free turbine, the first electric machine is permanently linked to the free turbine and therefore drives the shaft of the free turbine also when it is used to keep the first engine in standby mode at idle. This configuration is made possible by the fact that the free turbine of said first engine rotates at a lower speed than the main rotor, the main coupling means then being deactivated. Furthermore, the fact of driving the gas generator at idle by the first electric machine, by driving consequently both the free turbine and the gas generator, makes it possible to reconnect the shaft of the free turbine to the main rotor more quickly in case of need for quick start.

Alternatively, the second electric machine coupled to the gas generator only can be used to drive the gas generator of the first engine at idle, without driving the free turbine.

Moreover, in this case also, the first engine operating in the standby mode can be restarted by the first electric machine at least, during a quick restart phase.

In some embodiments, when the first electric machine is coupled to the shaft of the free turbine of the first engine by being in direct engagement therewith, the first engine is started by that of the first or of the second electric machine coupled to the gas generator only when the second engine is stopped, or by the first and/or the second electric machine when the second engine has been previously started.

In the case of a first ground start, the main rotor being stopped, the first electric machine in direct engagement with the shaft of the free turbine cannot be used to drive the gas generator and start the first engine, the inertia and the resistive torque of the main rotor being indeed too great. Consequently, the second electric machine, coupled to the gas generator only, is used to start the first engine. On the other hand, when the second engine has been previously started, then driving the main rotor, the first electric machine can be used to start the gas generator of the first engine, while driving the free turbine. The first engine then starts in turbines called linked turbines. Given this architecture and the presence of the two electric machines, it is thus possible to optimize the operation of the multi-engine aircraft and its start depending on the scenarios.

### BRIEF DESCRIPTION OF THE DRAWINGS

The invention and its advantages will be better understood upon reading the detailed description given below of different embodiments of the invention given as non-limiting examples. This description refers to the pages of appended figures, in which:

FIG. 1 represents a sectional view of a propulsion assembly for a twin-engine aircraft according to a first embodiment,

FIG. 2 represents a functional diagram of the propulsion assembly of FIG. 1,

FIG. 3 represents a sectional view of a propulsion assembly for a twin-engine aircraft according to a second embodiment,

FIG. 4 represents a functional diagram of the propulsion assembly of FIG. 3.

### DESCRIPTION OF THE EMBODIMENTS

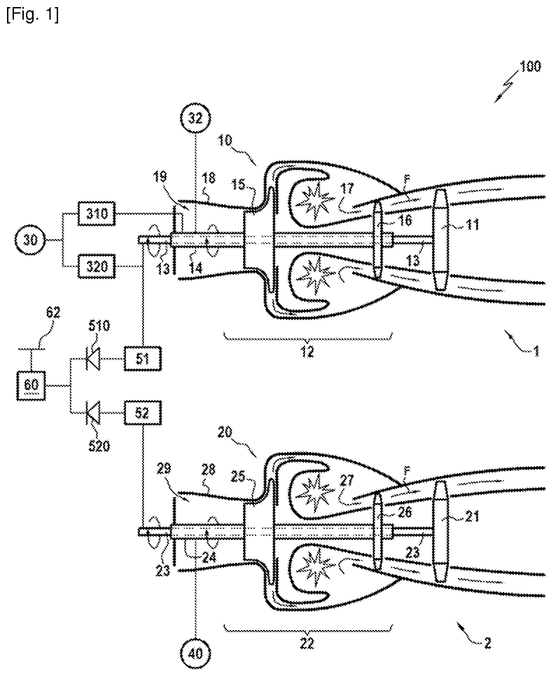

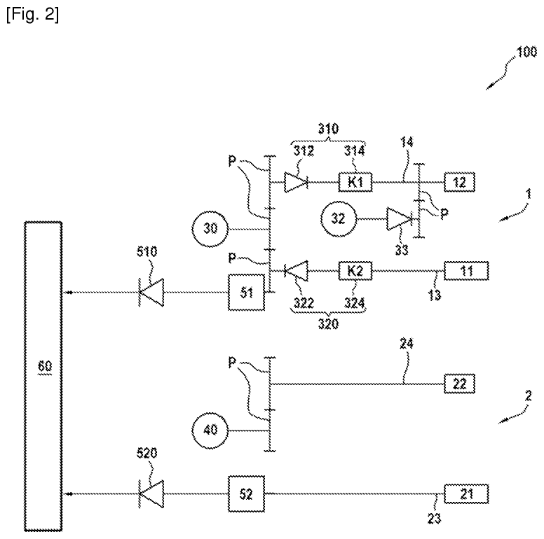

One architecture of a propulsion assembly 100 according to a first embodiment of the invention will be described in the remainder of the description, with reference to FIGS. 1 and 2.

It will be noted in general that, for the sake of clarity, the figures schematically represent in a functional and simplified manner an architecture of the device, without representing all the details of the elements constituting the turbomachines and the various power transmission members. Particularly, the pinions P allowing the shafts 13, 14 to be driven by the electric machines, and vice versa where appropriate, are schematically represented, and any speed ratios are not represented.

FIG. 1 schematically represents a propulsion assembly 100 of a twin-engine aircraft, comprising a first engine, in this example a first turbomachine 1 and a second engine, in this example a second turbomachine 2, driving in rotation transmission members 60 of a helicopter carrying a propeller or a main rotor 62. The turbomachines can be turbine engines or turboprop engines. Although the propulsion assembly described in the remainder of the description comprises two turbomachines, this example is not limiting, the invention also applying to propulsion assemblies of multi-engine aircrafts comprising more than two engines.

The first turbomachine 1 and the second turbomachine 2 are largely identical and have common characteristics. Also, the description below refers to both the first and second turbomachines 1, 2 for the characteristics that they have in common.

The first turbomachine 1 and the second turbomachine 2 respectively comprise a gas turbine 10, 20 having a gas generator 12, 22 and a free turbine 11, 21 able to be driven in rotation by a gas stream generated by the gas generator 12, 22. The free turbine 11, 21 is mounted on a shaft 13, 23 that transmits the rotational movement to a receiving member such as a main rotor 62 of the helicopter via the transmission members 60. According to this example, the gas turbine 10, 20 represented in FIG. 1 is of the front power take-off type with transmission by coaxial shaft. It could be very possible to consider, without departing from the framework of the present invention, a gas turbine with free turbine of the front power take-off type with transmission by inner or outer shaft, or a free turbine turbomachine of the rear power take-off type. In the same way, the turbine can be in direct engagement or integrate a speed reduction gear 51, 52 without calling into question the principle of the invention.

The gas generator 12, 22 includes a rotary shaft 14, 24 on which are mounted a compressor 15, 25 and a turbine 16, 26, as well as a combustion chamber 17, 27 disposed axially between the compressor 15, 25 and the turbine 16, 26 as long as the gas generator 12, 22 is considered along the axial direction of the rotary shaft 14, 24. The gas turbine 10, 20 has a casing 18, 28 provided with an air inlet 19, 29 through which the fresh air enters the gas generator 12, 22. After its intake into the enclosure of the gas generator 12, 22, the fresh air is compressed by the compressor 15, 25 which pushes it back towards the inlet of the combustion chamber 17, 27 in which it is mixed with fuel. The combustion taking place in the combustion chamber 17, 27 causes the burnt gases to be discharged at high speed towards the turbine 16, 26, which has the effect of driving in rotation the shaft 14, 24 of the gas generator 12, 22 and, consequently, the compressor 16, 26. The rotational speed of the shaft 14, 24 of the gas generator 12, 22 is determined by the fuel flow rate entering the combustion chamber 17, 27.

Despite the extraction of kinetic energy by the turbine 16, 26, the gas stream exiting the gas generator has significant kinetic energy. As understood from FIG. 1, the gas stream F is directed towards the free turbine 11, 21, which has the effect of causing an expansion in the free turbine 11, 21 leading to the rotation of the turbine wheel and of the shaft 13, 23.

The main rotor 62 is coupled, via the transmission members 60, to the shaft 13 of the free turbine 11 of the first gas turbine 10 by means of a first main coupling means 510 disposed between the speed reduction gear 51 and the transmission members 60. The main rotor 62 is also coupled, via the transmission members 60, to the shaft 23 of the free turbine 21 of the second gas turbine 20 by means of a second main coupling means 520 disposed between the speed reduction gear 52 and the transmission members 60.

Preferably, the first and second main coupling means 510, 520 comprise a free wheel mounted such that the rotation of the shaft 13, 23 can drive in rotation the main rotor 62 but such that, on the contrary, the rotation of the main rotor 62 cannot drive in rotation the shaft 13, 23 of the free turbine 11, 21. In other words, the free wheel of the first and second main coupling means 510, 520 can transfer a rotational torque only in the direction of the free turbine 11, 21 towards the main rotor 62, but not vice versa. On a helicopter, this free wheel is commonly called “engine free wheel”. It should be noted that the use of a free wheel for the main coupling means 510, 520 is not limiting, the free wheel being able to be replaced by any dog or clutch system.

The turbomachine 1 further includes a first electric machine 30, preferably reversible and comprising an electric motor able to operate reversibly as an electric generator. The first electric machine 30 is mechanically coupled to the shaft 14 of the gas generator 12 by means of first deactivatable coupling means 310.

The first deactivatable coupling means 310 comprise a first free wheel 312 and, preferably, a first speed adaptation reduction gear 314 disposed between the gas generator 12 and the first free wheel 312.

The first free wheel 312 is mounted such that the rotation of the first electric machine 30, operating in motor mode, can drive in rotation the gas generator 12 but such that, on the contrary, the rotation of the gas generator 12 cannot drive the first electric machine 30. In other words, the free wheel 312 of the first deactivatable coupling means 310 can transfer a rotational torque only in the direction of the first electric machine 30 towards the gas generator 12.

The first electric machine 30 is further mechanically coupled to the shaft 13 of the free turbine 11 by means of second deactivatable coupling means 320.

The second deactivatable coupling means 320 comprise a second free wheel 322 and, preferably, a second speed adaptation reduction gear 324 disposed between the free turbine 11 and the second free wheel 322.

The second free wheel 322 is mounted such that the rotation of the free turbine 11 can drive in rotation the first electric machine 30 then operating in generator mode, but such that on the contrary, the rotation of the first electric machine 30 cannot drive the free turbine 11. In other words, the free wheel 322 of the second deactivatable coupling means 320 can transfer a rotational torque only in the direction of the free turbine 11 towards the first electric machine 30.

The first and second free wheels 312 and 322 are mounted in opposition. In this case, they have opposite directions of engagement. Thus, when the first reversible electric machine 30 operates in motor mode to drive in rotation the shaft 14 of the gas generator 12 (first free wheel 312 engaged, i.e. first coupling means 310 activated), the second free wheel 322 does not transmit the rotational torque of the first electric machine 30 towards the shaft 13 of the free turbine 11 (second coupling means 320 deactivated). Conversely, when the shaft 13 of the free turbine 11 drives in rotation the first electric machine 30 operating as an electric generator (second free wheel 322 engaged, i.e. second coupling means 320 activated), the first free wheel 312 does not transmit the rotational torque of the first electric machine 30 towards the shaft 14 of the gas generator 12 (first coupling means 310 deactivated).

The first speed adaptation reduction gear 314 has a first reduction coefficient K1 preferably chosen such that the speed of the first electric machine 30 is adapted to the speed range required for starting the gas generator 12. The second speed adaptation reduction gear 324 has a second reduction coefficient K2 preferably chosen such that the speed of the first electric machine 30 is adapted to the speed range required to allow the supply of electricity.

To prevent the free turbine 11 from driving in rotation the shaft 14 of the gas generator 12, the first free wheel 312 must not be engaged. To do so, the reduction coefficients K1, K2 of the first reduction gear 314 and of the second reduction gear 324 are chosen appropriately. For example, but not necessarily, the reduction coefficients K1, K2 follow the ratios described in document FR2929324.

The turbomachine 1 also comprises a second electric machine 32 mechanically coupled to the shaft 14 of the gas generator 12 only, preferably via a third free wheel 33 allowing the second electric machine 32 not to be driven by the gas generator when it is not used.

In this example, while the first electric machine 30 is a high-power electric machine, in particular of several hundred kilowatts, the second electric machine 32 may be a starter usually used, with a power of the order of 10 kW. It should however be noted that this configuration is not limiting, the first and second electric machines being able to be reversed without departing from the framework of the invention.

Furthermore, the turbomachine 2 may be equipped with a third electric machine 40, preferably also of lower power than the first electric machine 30, for example a starter equivalent to the second electric machine 32. The third electric machine 40 is coupled only to the gas generator 22, and is able to drive the gas generator 22 during a start phase, and to be driven by said gas generator 22 after the start phase in order to generate electrical energy.

This architecture of the propulsion assembly 100 allows different operating modes described in the remainder of the description, and makes it possible to optimize the operation of the propulsion assembly 100.

The presence of the two turbomachines 1, 2 allows an operation in SEO (Single Engine Operative) mode, in which only the second turbomachine 2 is in operation, ensuring the entire power supply to the main rotor 62, the first turbomachine 1 being voluntarily stopped. When the SEO mode is engaged, the gas generator 12 is put on standby (or in assisted super-idle), that is to say it no longer provides power. On the other hand, to be started as quickly as possible, the gas generator 12 is driven in the ignition window (in a range from 5 to 30% of its nominal rotational speed) by the first electric machine 30 or by the second electric machine 32.

From this operation in SEO mode, it is possible to restart the first turbomachine 1 within the framework of a normal restart that is to say in a non-emergency situation requiring a quick restart, by optimizing the operation of the aircraft. Such an optimization method comprises, firstly, during the start phase of the first turbomachine 1, the fact of driving the gas generator 12 by the first electric machine 30 and/or the second electric machine 32, without driving the free turbine 11. Indeed, given the presence of the second free wheel 322, mounted in opposition to the first free wheel 312, the first electric machine 30 cannot drive in rotation the free turbine 11. Moreover, the second electric machine 32 is coupled to the gas generator 12 only, and therefore cannot drive the free turbine 11.

The first and second electric machines 30, 32 can be piloted by a monitoring unit (not represented). Thus, the first and/or the second electric machine 30, 32 drive the gas generator 12 via the free wheels 312, 33 respectively, allowing the start of the gas generator 12. Upon start of the gas generator 12, the hot gases drive the free turbine 11, the latter being connected to the main rotor 62 via the first free wheel 312, the speed reduction gear 51 and the free wheel of the first main coupling means 510.

In a second step, after the start phase, the free turbine 11 drives the first electric machine 30 via the second free wheel 322 in order to generate electrical energy. The first electric machine 30 can be electrically connected to an electric network of the propulsion assembly 100 in order to supply different electrical equipment (not represented). It will be noted that the steps above also apply to a normal start (and not a restart from the SEO mode) of the turbomachine 1, and in a non-emergency situation.

Furthermore, after the start phase and when the two gas generators 12, 22 are in operation (for example after the re-ignition of the turbomachine 1 to exit the SEO mode), the third electric machine 40 can generate electrical energy in redundancy with the first electric machine 30.

It will be noted that in the example illustrated in FIG. 2, given the presence of the third free wheel 33, the second electric machine 32 cannot be driven to operate in generator mode, and consequently only the first electric machine 30 can generate electrical energy. However, in the absence of the third free wheel 33, the first 30 and second 32 electric machines each generate electrical energy mutually without departing from the framework of the invention.

Moreover, it is also possible to perform a quick restart of the first turbomachine 1 from the standby mode. This quick restart is identical to the start or restart step described above, but the first high-power electric machine 30 is necessarily used in this case, alone or possibly complemented by the second electric machine 32 in order to optimize the reactivation time. Indeed, the power of the first electric machine 30 being of the order of several tens to a few hundred kilowatts, it is possible to start the gas generator 12 much more quickly than with a starter with a power of the order of 10 KW, usually used. This provides in particular an operational advantage in the case of medical rescue type missions, or during attempts at quick restart in flight.

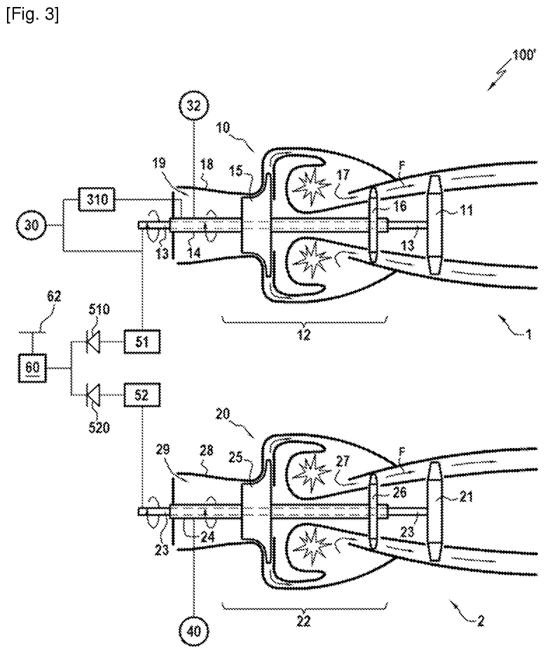

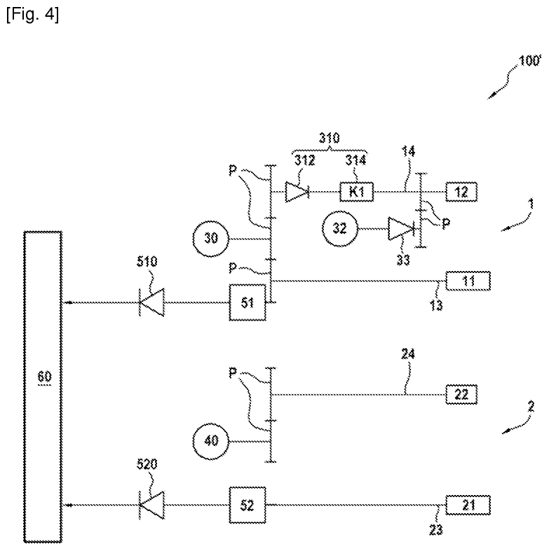

One architecture of a propulsion assembly 100′ according to a second embodiment of the invention will be described in the remainder of the description, with reference to FIGS. 3 and 4.

The characteristics of the propulsion assembly 100′ according to this second embodiment are largely identical to the propulsion assembly 100 according to the first embodiment, and will not be repeated. The operating modes described above with reference to the first embodiment are also applicable to the second embodiment.

The propulsion assembly 100′ according to the second embodiment differs, however, from the propulsion assembly 100 according to the first embodiment in that it does not comprise second deactivatable coupling means. In other words, the first electric machine 30 is in direct engagement with the shaft 13 of the free turbine 11, and is therefore permanently linked to the latter, including during the start phases.

Given this architecture, during an operation in SEO mode, the gas generator 12 of the turbomachine 1 can be kept idling by the second electric machine 32 so as not to drive the free turbine 11, or by the first electric machine 30. In this second case, the shaft 13 of the free turbine 11 is also driven. However, the main rotor 62 is driven by the turbomachine 2 and rotates at a higher speed than the shaft 13 of the free turbine 11, such that the main coupling means, and in particular the free wheel 510, is deactivated.

Similarly, during a first ground start, it is possible to start the gas generator 12 by using the first electric machine 30, if the turbomachine 2 has been previously ignited and is already driving the main rotor 62. On the other hand, if the turbomachine 2 has not yet been started, the gas generator 12 of the turbomachine 1 is started by using the second electric machine 32 which is coupled to the gas generator 12 only.

Although the present invention has been described with reference to specific exemplary embodiments, it is obvious that modifications and changes may be made to these examples without departing from the general scope of the invention as defined by the claims. Particularly, individual characteristics of the various illustrated/mentioned embodiments may be combined in additional embodiments. Consequently, the description and drawings should be considered in an illustrative rather than a restrictive sense.

It is also obvious that all the characteristics described with reference to one method are transposable, alone or in combination, to one device, and conversely, all the characteristics described with reference to one device are transposable, alone or in combination, to one method.

1. A propulsion assembly for a hybrid aircraft, in particular a multi-engine helicopter, comprising:
at least a first engine and a second engine each having a gas generator and a free turbine driven in rotation by a gas stream generated by the gas generator,
a main rotor coupled to the free turbine of the first and second engines,
the first engine comprising a first electric machine and a second electric machine of lower power than the first electric machine, one of the first or of the second electric machine being able to be coupled to the gas generator and to set the gas generator in rotation during a start phase of the engine, and being further able to be coupled to the free turbine in order to generate electrical energy after the start phase, the other of the first or of the second electric machine being coupled to the gas generator only.

2. The propulsion assembly according to claim 1, wherein the first electric machine is coupled to a shaft of the gas generator via first deactivatable coupling means configured to be activated during the start phase, and to be deactivated after the start phase.

3. The propulsion assembly according to claim 2, wherein the first electric machine is coupled to a shaft of the free turbine by being in direct engagement therewith.

4. The propulsion assembly according to claim 2, wherein the first electric machine is coupled to a shaft of the free turbine via second deactivatable coupling means, the first and second deactivatable coupling means being configured so as not to be activated simultaneously.

5. The propulsion assembly according to claim 4, wherein the first deactivatable coupling means comprise a first free wheel, the second deactivatable coupling means comprise a second free wheel, and the first and second free wheels are mounted in opposition.

6. The propulsion assembly according to claim 4, wherein the first deactivatable coupling means comprise a first reduction gear having a first reduction coefficient, while the second deactivatable coupling means comprise a second reduction gear having a second reduction coefficient, and the ratio of the first and second reduction coefficients is smaller than a limit value.

7. The propulsion assembly according to claim 1, wherein, when the second engine alone drives the main rotor, the gas generator of the first engine is kept in a standby mode, via the first or the second electric machine.

8. The propulsion assembly according to claim 1, wherein the second electric machine is coupled to the gas generator only, via a free wheel.

9. The propulsion assembly according to claim 1, wherein the second engine comprises a third electric machine able to drive the gas generator of the second engine during a start phase, and to be driven by said gas generator after the start phase in order to generate electrical energy.

10. A hybrid aircraft comprising a propulsion assembly according to claim 1, the hybrid aircraft being a multi-engine helicopter, in particular a twin-engine helicopter.

11. A method for optimizing the operation of a multi-engine aircraft using a propulsion assembly according to claim 1, wherein, during a start phase of the first engine, the first electric machine and/or the second electric machine drive the gas generator of said first engine, and after the start phase, the free turbine of said first engine drives one of the first electric machine or of the second electric machine in order to generate electrical energy.

12. The method according to claim 11, wherein the second engine is able to operate alone, the first engine then operating in a standby mode by being driven at idle by the first or the second electric machine, the first engine operating in the standby mode being restarted by the first electric machine at least during a quick restart phase.

13. The method according to claim 11, wherein, during a start phase of the first engine, the first electric machine and/or the second electric machine drive the gas generator of said first engine without driving the free turbine, when the first electric machine is coupled to the shaft of the free turbine via the second deactivatable coupling means comprising the second free wheel.

14. The method according to claim 11, wherein the second engine is able to operate alone, and wherein, when the first electric machine is coupled to the shaft of the free turbine of the first engine by being in direct engagement therewith, the first engine then operating in a standby mode is driven at idle by the second electric machine coupled to the gas generator only, or by the first electric machine, the main rotor being coupled to the free turbine of the first engine via a main coupling means, the main rotor driven by the second engine rotating at a higher speed than the shaft of the free turbine of the first engine such that the main coupling means is deactivated.

15. The method according to claim 11, wherein, when the first electric machine is coupled to the shaft of the free turbine of the first engine by being in direct engagement therewith, the first engine is started by that of the first or of the second electric machine coupled to the gas generator only when the second engine is stopped, or by the first and/or the second electric machine when the second engine has been previously started.
